(19) United States
(12) Patent Application Publication
(10) Pub. No.: US 2018/0121862 A1
(43) Pub. Date: May 3, 2018

(54) VEHICLE SERVICE MANAGEMENT SYSTEM

(71) Applicant: CMT GROUP, LLC, Cleveland, OH (US)

(72) Inventors: Keith GARRY, Richmond Heights, OH (US); Kenneth MINARDO, Mayfield Heights, OH (US); Trevor GILE, Chagrin Falls, OH (US)

(21) Appl. No.: 15/801,407

(22) Filed: Nov. 2, 2017

Related U.S. Application Data
(60) Provisional application No. 62/416,381, filed on Nov. 2, 2016.

(51) Int. Cl. G06Q 10/06; G06Q 10/00; G06Q 10/10

(52) U.S. Cl. CPC G06Q 10/063118; G06Q 10/1095; G06Q 10/06314; G06Q 10/20

(57) ABSTRACT

A vehicle management system, includes a customer interface module for collecting customer data associated with a service of a vehicle from a customer; at least one employee interface module for collecting service data associated with the service of the vehicle; and a service advisor module. The service advisor module includes a first communication interlace module for communicating with the customer interface module and for receiving the customer data; a second communication interface module for communicating with the at least one employee interface module and for receiving the service data and to communicate notifications; a service advisor database for storing the customer data and the service data, wherein the service data comprises estimated costs of service data and estimated time for service completion data; a service advisor interface configured to display the customer data and the service data and to receive inputs from a service advisor; and an estimator module.

### CROSS-REFERENCE TO RELATED APPLICATION

This application claims priority from US Patent Application No. 62/416,381 filed on Nov. 2, 2016, which is incorporated by reference herein in its entirety.

### TECHNICAL FIELD

Embodiments of the subject matter disclosed herein relate to vehicle service and the management of a vehicle service center.

### BACKGROUND

Service advisors at a vehicle service center have myriad responsibilities pertaining to interfacing with customers and managing the vehicle service and repair process. Conventionally, service advisors approach these responsibilities by using separate computer software and typical communication methods.

Presently, a service advisor at a vehicle service center is tasked with responsibilities such as scheduling service appointments, providing cost estimates, time estimates, reserving rental cars, booking shuttle services, managing repair technicians, and managing or coordinating schedules of other employees. Much of the information required to accomplish these tasks originates from different sources and ends up stored in distinct systems or databases. For example, a receptionist may greet a customer at the front desk and write down the customer's information. Meanwhile, an employee may have called in sick, and the auto manufacturer of the customer's vehicle may have just issued a recall notice for a defective part. With conventional systems, all of this information is located in separate locations, requiring the service advisor to manually seek out the information and create a service plan for the customer. This creates a problem with efficiency and accuracy, resulting in slower interactions with customers and mistakes. These slower interactions and mistakes can create unsatisfied customers and have a negative impact on customer retention.

One solution would be to keep a single database that allows direct access for all relevant parties to input information. The database could be open to all employees and customers and would enable them to input the necessary information. However, this could prove to be burdensome and confusing on customers and may cause security and privacy concerns. A system as described below is effective in solving these issues.

### BRIEF DESCRIPTION

In an embodiment, the subject innovation provides a system comprising a customer interface component that is configured to collect customer data associated with a service of a vehicle from a customer. The system further comprises at least one employee interface component that is configured to collect service data and to communicate notifications from an employee. The service data and notifications are associated with the service of the vehicle. The system further comprises a service advisor component. The service advisor component includes a communication interface configured to communicate with the customer interface component and the at least one employee interface component to receive the customer data and the service data. A service advisor database is configured to store the customer data and the service data. A service advisor interface is configured to display the customer data, the service data, and service advisor alerts and also receive inputs from a service advisor. A processor is configured to generate the service alerts and calculate at least one of a price quote or a time estimate based on the customer data and the service data.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an example vehicle management system;

FIG. 2 is an illustration of an example vehicle management system;

FIG. 3 is a block diagram of an exemplary, non-limiting service advisor application according to one or more aspects;

FIG. 4 is a schematic block diagram illustrating a suitable operating environment for aspects of the subject disclosure;

FIG. 5 is a schematic block diagram illustrating a suitable environment for delivery of data in accordance with the subject disclosure; and

FIG. 6 is a schematic block diagram illustrating illustrates a cloud computing environment in accordance with the subject innovation.

FIG. 7 is a flow chart illustrating the steps of an example method for using a vehicle management system for calculating a price quote and a time estimate fora vehicle service

APPENDIX A is a document that describes aspects of the claimed subject matter, and this Appendix forms part of this specification.

### DETAILED DESCRIPTION

Embodiments of the invention relate to methods and systems that relate to managing, coordinating, and presenting information pertinent to the operations of a service advisor or other employees at a vehicle service center. The system can receive data from customers, service advisors, or other employees. The system can store this data, process the data, and present the data to the user (e.g. service advisor or other employee) to facilitate service transactions with customers.

The term “employee” as used herein can be defined as any person who works for a vehicle service center, vehicle dealership, or automotive manufacturer, or any person who is involved in the vehicle manufacture, vehicle service or vehicle sales process. This can include, but is not limited to, a service advisor, auto mechanic, service technician, sales associate, sales manager, business development associate, receptionist, or an automotive manufacturer's representative, among others.

The term “component” as used herein can be defined as a portion of hardware, a portion of software, or a combination thereof. A portion of hardware can include at least a processor and a portion of memory, wherein the memory includes an instruction to execute.

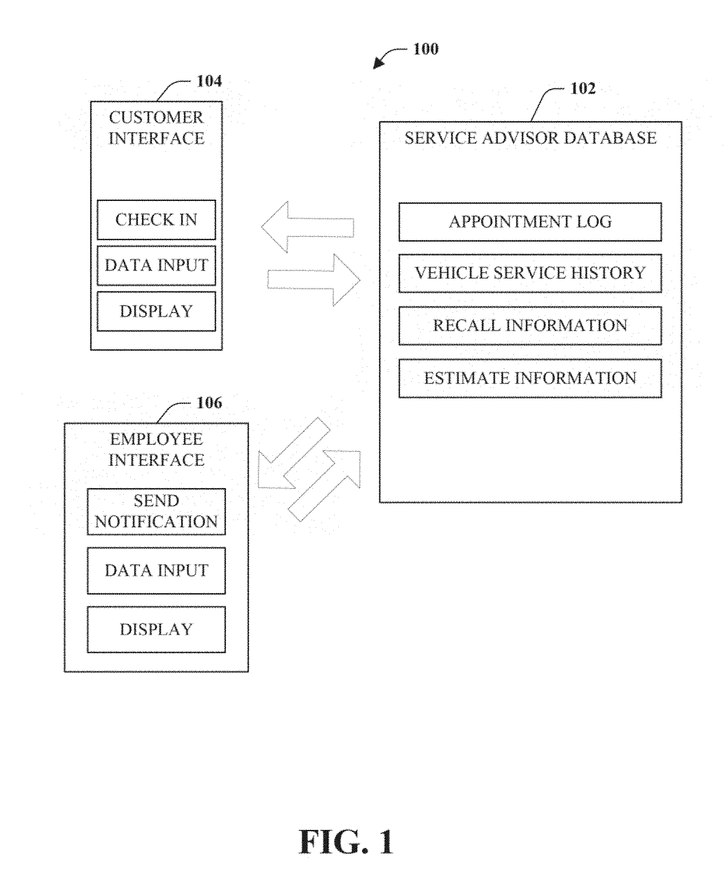

FIG. 1 illustrates a system 100 that is configured to receive data inputs through a customer interface 104 (also referred to as a customer component) and an employee interface 106 (also referred to as an employee component). This data can be communicated to a service advisor database 102 which can then organize and store the data. It is to be appreciated that there can be any suitable number of customer interfaces 104 and employee interfaces 106 such as interfaces 1 to N, where N is a positive integer.

As illustrated in FIG. 1, the customer interface 104 allows a customer to check in upon arrival. In particular, the customer interface receives notification of a customer arrival and communicates the notification of the customer arrival to the first communication interface. The customer interface can also allow a customer to input additional data such as miscellaneous comments, a request for a shuttle service, a request for a rental/loaner vehicle, or an indication that the customer will wait for the service to be completed, among other data. In certain embodiments, the customer interface 104 can be a touch screen, a mobile device, a tablet, or a computer. In other embodiments, an employee may interface with the customer interface 104 on behalf of the customer.

The employee interface 106 can allow an employee to input data. For example, the employee can use the employee interface 106 to send notifications to the service advisor, send messages to the service advisor, input data related to a customer, a vehicle, or an active repair, input status updates, input work schedule changes or requests, input prospective customer information, or input vehicle recall information, among others. The employee interface 106 can be a touch screen, a mobile device, a tablet, or a computer.

The employee interface 106 may be designed specifically for different types of employees depending on its intended use. In certain embodiments, an employee interface 106 can be located near the workspace of a service technician. The service technician or auto mechanic can use an employee interface 106 to input the status of a current repair or send a notification or message to the service advisor indicating that a part must be retrieved or ordered. In other embodiments, an employee interface 106 can be located in a sales showroom or in the office of a sales associate. The sales associate can use the employee interface 106 to input information regarding a potential service customer such as name, contact information, and information about a vehicle that the potential service customer has recently leased or purchased. In another embodiment, an employee interface 106 can be located near a business development associate. The business development associate can use the employee interface 106 to input information regarding a potential service customer such as name, contact information, availability, and information about the potential customer's vehicle.

In certain embodiments, the customer interface 104 and the employee interface 106 can be part of the same hardware or share certain components. In other embodiments, the customer interface 104 and employee interface 106 can exist in the same hardware as the service advisor database 102 and the master virtual device 202 or share certain components.

The service advisor database 102 can aggregate the data collected from the customer interfaces 104 and employee interfaces 106 as well as data inputted directly into the database 102 by a service advisor. As shown in FIG. 1, the service advisor database 102 can use the aggregated data to create an appointment log, and a vehicle service history log. These logs can associate past service histories and past and future appointments to specific customers and/or customer vehicles. The service advisor database 102 can also include recall information provided by automobile manufacturers. This allows a user to perform a recall search or receive automated recall alerts for an associated customer or vehicle without needing to consult a separate system. The service advisor database 102 can further include price information and time estimations necessary to calculate estimates on the price of a given repair and the time necessary to complete the repair.

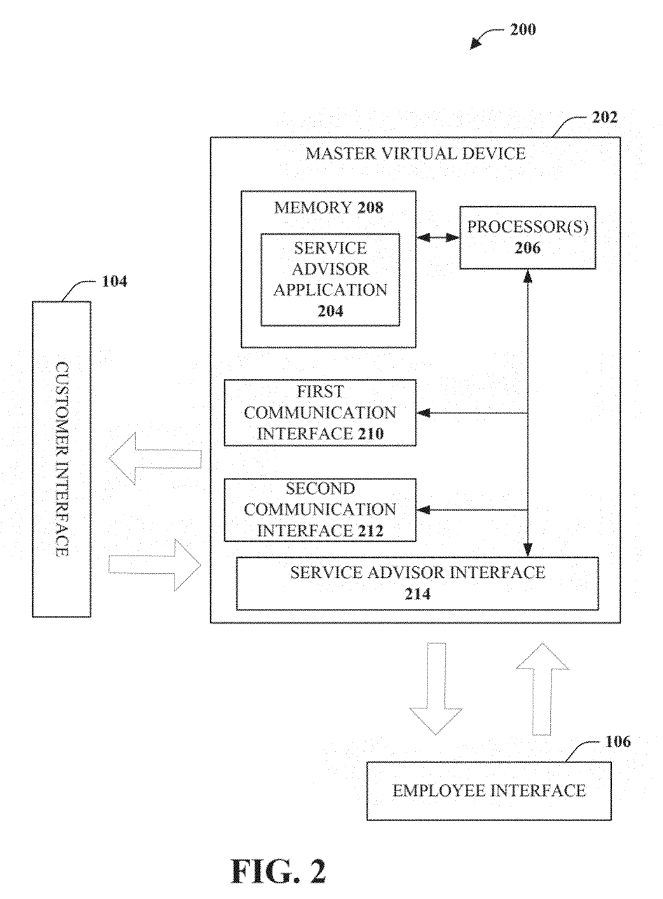

Turning to FIG. 2, a system 200 is illustrated utilizing the master virtual device 202 and the service advisor application 204 to process check in/check out information via the customer interface 104. Master virtual device 202 includes one or more processor(s) 206 configured to execute computer-executable instructions such as instructions composing service advisor application 204. Such computer-executable instructions can be stored on one or more computer-readable media including a non-transitory, computer-readable storage medium such as memory 208 of master virtual device 202.

Master virtual device 202 includes a first communication interface 210 and a second communication interface 212. As shown in FIG. 2, first communication interface 210 can enable electronic communications between the master virtual device 202 and the one or more customer interfaces 104. It is to be appreciated that the first communication interface 210 can be a wired or wireless interface including, but not limited to, a LAN cable, an Ethernet cable, a USB interface, a serial interface, a WiFi interface, a fiber optic interface, a cellular radio interface, a satellite interface, a short-range RF interface Bluetooth), an infrared interface, a near-field communication (NFC) interface, an interface for the interact, etc. Second communication interface 212 can enable electronic communications between one or more employee interfaces 106 and the master virtual device 202. As such, second communication interface 212 can be a wired or wireless interface including, but not limited to, a LAN cable, an Ethernet cable, a USB interface, a serial interface, a WiFi interface, a fiber optic interface, a cellular radio interface, a satellite interface, a short-range RF interface (Bluetooth), an infrared interface, a near-field communication (NFC) interface, an interface for the Internet, etc. While shown separate in FIG. 2, first communication interface 210 and second communication interface 212 can be a single interface or an interface capable of simultaneous communication over multiple connections.

Master virtual device 202 can further include a service advisor interface 214 that comprises various elements to Obtain user input from, for example, a service advisor, and to convey output to the user. For instance, service advisor interface 214 can comprise a touch display which operates as both an input device and an output device. In addition, service advisor interface 214 can also include various buttons, switches, keys, etc. by which a service advisor can input information to master virtual device 202, and other displays, LED indicators, etc. by which other information can be output to the service advisor.

In accordance with an embodiment, master virtual device 202 is a computing device, which can be hosted at a physical location or site of the customer interface 104, e.g. at a vehicle service facility. However, it is to be appreciated that the master virtual device 202 can be other portable form-factors such as a laptop computer, a convertible laptop, a cell phone, a PDA, a pocket computing device, a watch computing device, or the like. Moreover, it is to be appreciated that the functionality described herein with respect to the master virtual device 202 can be performed by a desktop computer, or other larger, less portable computing device such as a physical server. That is, service advisor application 204 can be installed and executed on substantially any computing device provided that such a computing device can communicate with the one or more customer interfaces 104 and the one or more employee interfaces 106 as described above with regard to FIG. 1.

It is to be appreciated that the master virtual device 202 and/or the service advisor application 204 can be a network or a portion of a network, wherein the network is at least one of a website, a server, a computer, a cloud-service, a processor and memory, or a computing device connected to the Internet and connected to the one or more customer interfaces 104. In general, the network can be coupled to one or more devices via wired or wireless connectivity in which data communications are enabled between the network and at least one of a second network, a subnetwork of the network, or a combination thereof lit is to be appreciated that any suitable number of networks can be used with the subject innovation and data communication on networks can be selected by one of sound engineering judgment and/or one skilled in the art.

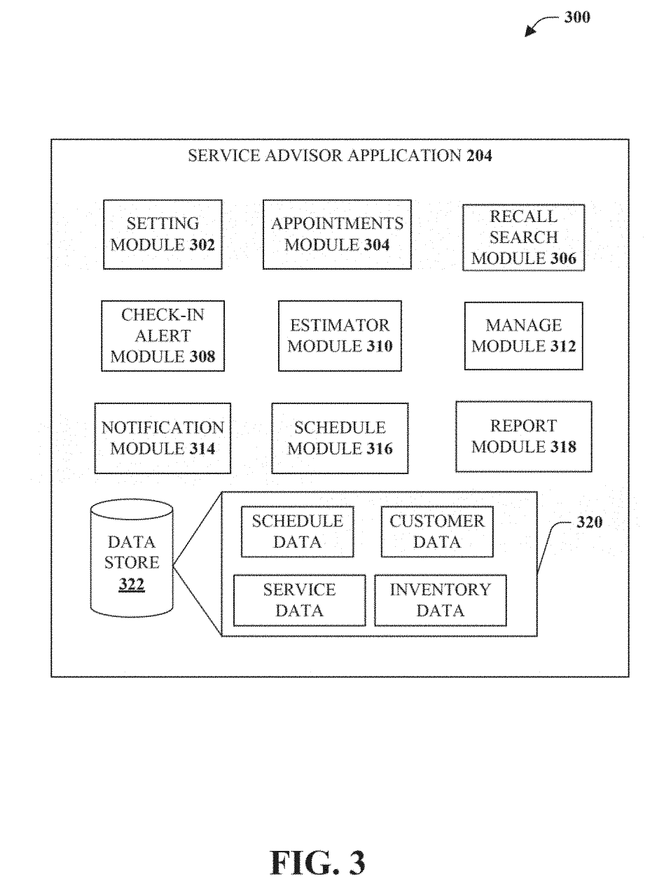

FIG. 3 illustrates a block diagram of an exemplary, non-limiting embodiment of the service advisor application 204 according to one or more aspects. Service advisor application 204 comprises computer-executable instructions and computer-readable data stored on memory 208 of the master virtual device 202. The computer-executable instructions of service application 204 are executable by processor 206 of master virtual device 202.

As shown in FIG. 3, the service advisor application 204 can include one or more modules (e.g., settings module 302, appointments module 304, recall search module 306, check-in alert module 308, estimator module 310, management module 312, notification module 314, schedule module 316, and report module 318, among others) and data 320 stored on a data store 322 that stores data 320 (e.g., schedule data, customer data, inventory data, service data, etc.). The one or more modules can include computer-executable instructions implementing various features, processes, operations, etc. of the service advisor application 204.

Management module 312 can provide administration functions, configuration of diagnostic applications, or the like. For example, management module 312 can enable administration (e.g., retrieval, display, and editing) of customer profiles. In addition, management module 312 can enable configuration of payment information.

As shown in FIG. 3, the service advisor application 204 can include various support data 320. Support data 320 can include schedule (e.g., customer appointments, employee work schedules, etc.), inventory data (e.g., parts available, etc.), customer data (e.g., customer account information, user names, passwords, customer names, customer addresses/contact information, customer payment information, customer vehicle information, etc.), service data (e.g., estimated cost of services, estimated time for service completion, service history for individual customers, etc.), and the like.

The settings module 302 can be configured to provide data communications related to configuring a parameter related to the master virtual device 202 and/or the service advisor application 204. In terms of the master virtual device 202, the settings component 302 can be used to configure communications settings between the master virtual device 202 and the one or more customer interfaces 104. In another example, the settings module 302 can be utilized to configure communication settings between the master virtual device 202 and the one or more employee interfaces 106. For example, the settings module 302 can allow definition of the following parameters: number of customer or employee interfaces (104, 106) for connectivity to the master virtual device 202; credentials required for connectivity; security protocol definitions; authentication of user (either customer or employee) desired notifications or alerts related to the vehicle service process; and the like.

The appointments module 304 can be configured to organize and coordinate new and existing scheduled service appointments. The appointments module 304 can collect all information and data related to a customer's appointment. The customer associated with an appointment can be assigned a custom label (e.g. comeback, first visit, recall, waiter, rental car, shuttle, previous complaint, etc.) to communicate to the service advisor the customer's status or the customer's needs. The appointments module 304 allows employee users to know why a customer is coming in before the customer arrives. In an embodiment, the appointments module 304 can track any suggested repairs or services that were declined by the customer. This information is helpful so that the service advisor or other employee can suggest the repair or service during a subsequent appointment.

A recall search module 306 can be configured to receive and aggregate all recall information from automotive manufacturers. The recall information can be input by a user or administrator, or the recall information can be transmitted directly from an automotive manufacturer. The recall search module 306 can include a search function that allows a user to search for relevant recall information directly from the service advisor application 204, service advisor interface 214, or an employee interface 106. In some embodiments, the recall search module 306 can automatically associate recall information to a customer's account or customer's vehicle information so that the customer can be contacted or the service advisor application 204 automatically can display a notification regarding the recall information when a customer arrives for a service appointment.

A check-in alert module 308 can ^{he} configured to alert a user (employee or service advisor) when a customer arrives and checks in. The check-in alert module 308 allows a service advisor to greet the customer by name upon arrival. Upon check-in, a customer (or an employee on behalf of the customer) enters relevant information into a customer interface 104. This information can be transmitted from the customer interface 104 to the master virtual device 202 and processed/displayed by the chock-in alert module.

An estimator module 310 can be configured to provide a quote on time or prices for a vehicle service. The estimator module 310 can apply stored time rates and price rates, to collected customer data, service data, and advisor service data, using algorithms/calculations to provide the quotes. These time rates and price rates can be updated in real time based on changes to part cost, labor cost, and historical changes in average time to completion of each service type.

A notification module 314 can facilitate communications between different employees. For example, a business development associate, a sales associate, or another service advisor can send a personalized message to appear on the service advisor interface 214. As another example, a service advisor can send a message requesting immediate help to a service manager. As a further example, a service advisor can send a group message that appears on multiple other interfaces directed to multiple other employees such as a business development associate, another service advisor, or a manager. The notification module 314 can allow a user to specify varying codes for different types of messages (e.g., Code Red, Code Blue, Code Green, etc.).

A schedule module 316 can aggregate and organize service appointments made by customers. The schedule module 316 can also aggregate and organize employee work schedules. The schedule module 316 can also allow the service advisor application 204 to create employee break schedules and training schedules. Further, the schedule module 316 can keep logs and manage customer pickup times and schedule shuttle schedules so that the shuttles can depart at the proper time to pick up a customer based on their distance. Further, the schedule module 316 can alert a user when a rental car is approaching the facility or when special order parts have arrived. These notifications can appear on a customer interface 104, an employee interface 106, the service advisor interface 214, or can be sent via text message or e-mail to the customer or an employee. The schedule module 316 can integrate the service appointment schedules with the employee work schedules to ensure proper staffing and manpower. An employee can use the service advisor application 204 to request time off or indicate vacation days, sick time, etc.

A report module 318 is able to provide reports regarding customers, service appointments/schedules, services performed, hours per repair, revenue, costs, service history, open repair orders, employee work time, employee work schedules, or employee pay. The report module 318 can also provide information regarding customer “hotlists”. These hotlists provide a list of customers that are significant for a variety of reasons. For example, a hotlist can he created that includes active prospective customers that a car dealership feels are the best prospects, customers that do not show up for an appointment, customers who have not returned for a service visit within a configurable amount of time (e.g. 9 months), customers who order parts but are not currently assigned to a service advisor, or a list of the customers identified as desirable to provide a follow-up review. These hotlists can also provide a personalized e-mail template or phone script to an employee.

The service advisor application 204 can also allow a user to input a customer's license plate number when they arrive with a competitor's lease. The service advisor application 204 can alert a user (e.g. service advisor or sales associate) to follow up with the customer at a later time (e.g. soon before, or following the competitor lease expiration). The service advisor application 204 can also include to-do list functionality with digital sticky notes that can be placed locally on a single interface or displayed on multiple interfaces.

Although a single data store 322 is illustrated, any suitable number of data stores can be used with the system 100. The number of data stores and the organization where the data is stored there on can be selected with sound engineering judgment and/or by one skilled in the art without departing from the scope of the subject innovation.

It is to be appreciated that any component or module from the service advisor application 204 can be a stand-alone component/module, a sub-component, a sub-module, an integrated component with another component, an integrated module within another module, a system, a portion of a system described herein and/or a combination thereof. Thus, the functionality described for the service advisor application 204 can be performed by any number of the components or modules discussed.

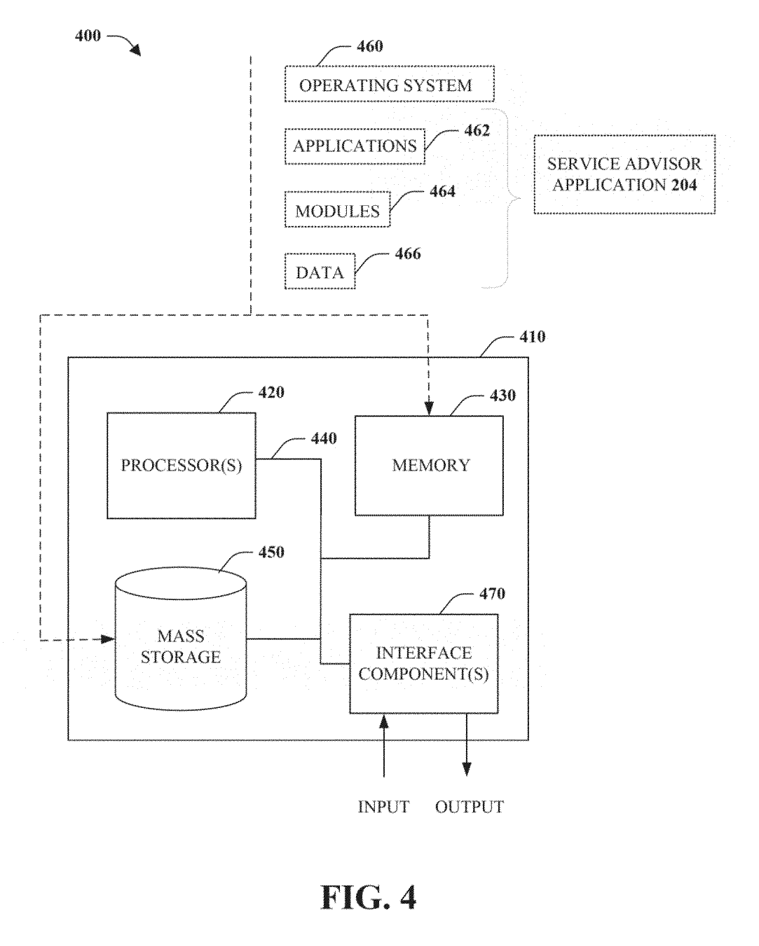

In order to provide a context for the claimed subject matter, FIG. 4 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), portable gaming device, smartphone, tablet, Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 4, illustrated is an example general-purpose computer 410 or computing device (e.g., desktop, laptop, server, hand-held, programmable consumer or industrial electronics, set-top box, game system . . . ). The computer 410 includes one or more processor(s) 420, memory 430, system bus 440. mass storage 450, and one or more interface components 470. The system bus 440 communicatively couples at least the above system components. However, it is to he appreciated that in its simplest form the computer 410 can include one or more processors 420 coupled to memory 430 that execute various computer executable actions, instructions, and or components stored in memory 430.

The processor(s) 420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 420 may also be implemented as a combination of computing devices, for example a combination of a DSP and a microprocessor, a plurality of microprocessors, multi-core processors, one or more microprocessors in conjunction with a DSP core, or any other such configuration.

The computer 410 can include or otherwise interact with a variety of computer-readable media to facilitate control of the computer 410 to implement one or more aspects of the claimed subject matter. The computer-readable media can be any available media that can be accessed by the computer 410 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, hut is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can he accessed by the computer 410.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above Should also be included within the scope of computer-readable media.

Memory 430 and mass storage 450 are examples of computer-readable storage media. Depending on the exact configuration and type of computing device, memory 430 may be volatile (e.g., RAM), non-volatile (e.g., ROM, flash memory . . . ) or some combination of the two. By way of example, the basic input/output system (BIOS), including basic routines to transfer information between elements within the computer 410, such as during start-up, can be stored in nonvolatile memory, while volatile memory can act as external cache memory to facilitate processing by the processor(s) 420, among other things.

Mass storage 450 includes removable/non-removable, volatile/non-volatile computer storage media for storage of large amounts of data relative to the memory 1030. For example, mass storage 450 includes, but is not limited to, one or more devices such as a magnetic or optical disk drive, floppy disk drive, flash memory, solid-state drive, or memory stick.

Memory 430 and mass storage 450 can include, or have stored therein, operating system 460, one or more applications 462, one or more program modules 464, and data 466. The operating system 460 acts to control and allocate resources of the computer 410. Applications 462 include one or both of system and application software and can exploit management of resources by the operating system 460 through program modules 464 and data 466 stored in memory 430 and/or mass storage 450 to perform one or more actions. Accordingly, applications 462 can turn a general-purpose computer 410 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the service advisor application 204 (associated functionality, modules, and/or portions thereof) can be, or form part, of an application 462, and include one or more modules 464 and data 466 stored in memory and/or mass storage 450 whose functionality can be realized when executed by one or more processor(s) 420. Moreover, it is to be appreciated that the software, firmware, or combination thereof to perform the functionality of the described components herein can be downloaded, installed, or a combination thereof from any host. For instance, the host can be an online store, a website, an IP address, an application store, a network, a storage medium, a portable hard disk, a server, or the Internet.

In accordance with one particular embodiment, the processor(s) 420 can correspond to a system on a chip (SOC) or like architecture including, or in other words integrating, both hardware and software on a single integrated circuit substrate. Here, the processor(s) 420 can include one or more processors as well as memory at least similar to processor(s) 420 and memory 430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the service advisor application 204 (associated functionality, modules, and/or portions thereof) can be embedded within hardware in a SOC architecture.

The computer 410 also includes one or more interface components 470 that are communicatively coupled to the system bus 440 and facilitate interaction with the computer 410. By way of example, the interface component 470 can be a port (e.g., serial, parallel, PCMCIA, USB, FireWire . . . ) or an interface card (e.g., sound, video . . . ) or the like. In one example implementation, the interface component 470 can be embodied as a user input/output interface to enable a user to enter commands and information into the computer 410 through one or more input devices (e.g., pointing device such as a mouse, trackball, stylus, touch pad, keyboard, microphone, joystick, game pad, satellite dish, scanner, camera, other computer . . . ). In another example implementation, the interface component 470 can be embodied as an output peripheral interface to supply output to displays (e.g., CRT, LCD, plasma . . . ), speakers, printers, and/or other computers, among other things. Still further yet, the interface component 470 can be embodied as a network interface to enable communication with other computing devices (not shown), such as over a wired or wireless communications link.

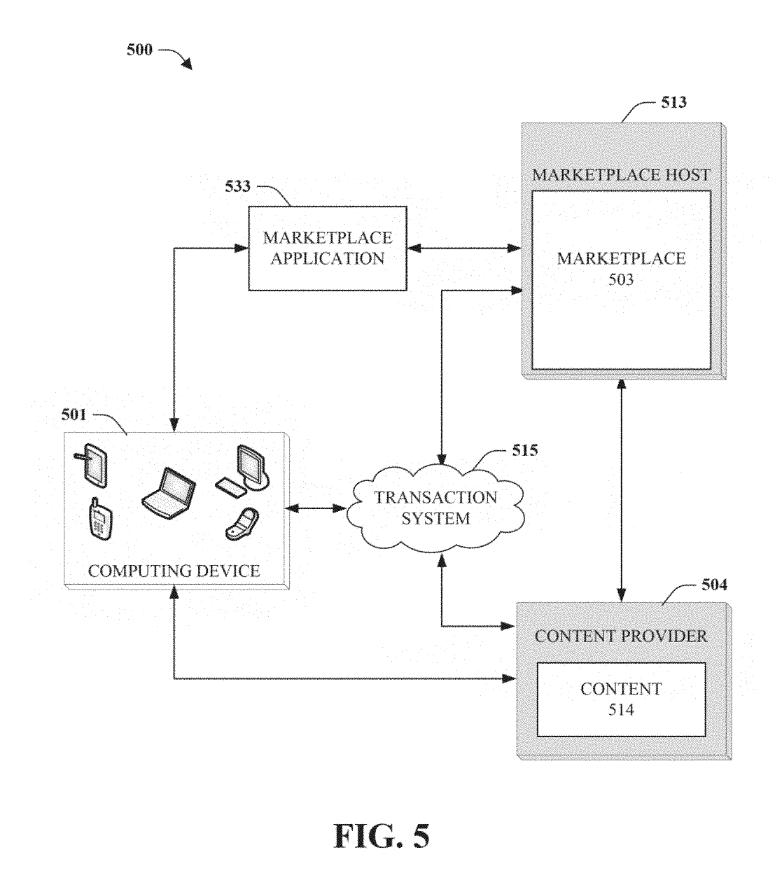

FIG. 5 illustrates an operating environment 500 that can be used with the subject innovation and in particular, the service advisor application 204. The operating environment 500 includes a computing device 501 (e.g., device smartphone, a tablet, a laptop, a desktop machine, a portable gaming device, a device with Internet connectivity, among others), a user, a marketplace 503, a content provider 504, and content 514. The operating environment 500 is configured to deliver data (e.g., content 514) to the computing device 501 based upon a request from the computing device 501 (e.g., typically initiated by a user of the computing device 501). However, it may be appreciated that the delivery of data to the computing device 501 can he pushed to the computing device 501 and further approved (e.g. acceptance of license agreement, among others) by the user. The data delivered can he from a content provider 504, wherein the data can be delivered directly to the computing device 501 or indirectly delivered to the computing device 501 via the marketplace 503 and/or the marketplace applications 533. In an embodiment, the computing device 501 can utilize a transaction system 515 that facilitates purchasing data via at least one of the marketplace 503, the marketplace applications 533, the content provider 504, and the like. The transaction system 515 can be configured to utilize a charging gateway to facilitate completing a transaction between entities (e.g., user, content provider, marketplace, among others).

The computing device 501 and the marketplace 503 can be configured to communicate across a network, for example, wherein the marketplace 503 is accessed via the marketplace application 533 or a user interface (UI) associated with one of the marketplace 503 or the marketplace host 513. The marketplace 503 can be hosted by a marketplace host 513 associated with any suitable host, server, computer, data store, and the like.

In one embodiment, the computing device 501 is mobile so that it may function for a period of time without requiring a physical connection to a power source or network provider. For example, a cellular network or a Wi-Fi connection can be used by the computing device 501 in order to transmit and/or receive data within the operating environment 500.

A user can employ the computing device 501 tsar the device's intended functions as well as communicating data with the marketplace 503 and/or marketplace host 513. Commonly, the user purchases content 514 and/or products from the content provider 504 via the transaction system 515. It is to be appreciated that the marketplace 503 can be in an electronic form such as a website, the marketplace application 533, or an executable program. In a preferred embodiment, the marketplace 503 takes the form of the marketplace application 533 configured to run on the user's computing device 501. The marketplace application 533 may be utilized to install the content 514 from the content provider 504 onto the computing device 501.

The marketplace 503 can further connect the content provider 504 and/or the content 514 of the content provider 504 with the computing device 501 to allow the user to receive content 514 via a download (e.g., communication of data packets). The marketplace 503 can offer the user a variety of content 514 for purchase (via the transaction system 515) or for free of charge. The content 514 offered by the marketplace 503 may also come from the marketplace host 513. For example, the content provider 504 can have a website for direct delivery of content 514 or have content 514 hosted in the marketplace 503 by the marketplace host 513. Thus, in such an example, a user can directly receive data or content from the website of the content provider 504 or use the marketplace application 533 to identify the content 514 for receipt through the marketplace 503. Moreover, the content 514 can be tailored to the computing device 501. For instance, a first content can be built for a first computing device having a first operating system and a second content can be built for a second computing device having a second operating system, wherein the first content and the second content can be from the content provider 504.

In some embodiments, the system 500 utilizes the transaction system 515. The transaction system 515 can include a transaction gateway that facilitates transactions between at least the marketplace host 513, one or more users, the marketplace 503, and/ or the content provider 504. When the user purchases content 514 from the marketplace 503 or content provider 504, a charging gateway can receive a request to apply a charge to a user account (e.g., a monetary value via an electronic transaction via an account) owned or authorized by the user. For example, the user account can he, hut is not limited to being, a credit card account, an account with the content provider 504 or marketplace host 513, a bank account, a debit account, an e-commerce account (e.g. Pay-Pale), an electronic account, a savings account, and the like.

The transaction gateway can store transaction data (e.g., user account, username, password, data related to the user, data related to the computing device 501, among others) specific to a transaction to receive content 514. The transaction gateway can further collect and/or store data regarding one or more users, wherein the data can be, but is not limited to, credit card numbers, to make it easier for the one or more users to engage in multiple transactions (e.g., simultaneously and/or various points in time). The transaction gateway can further reverse a transaction between one or more parties involved, such as providing a refund to the user.

It is to be appreciated that a purchase may not require the transfer of finances. For example, the content 514 on the marketplace 503 could be free to download. Additionally, a portion of the transaction system 515 can be integrated into at least one of the content provider 504, the marketplace host 513, the marketplace application 533, or a combination thereof. In another embodiment, the first content 514 can be free but additional content related to the first content 514 can require a purchase.

The content provider 504 can create content 514 (e.g., also referred to as products, software, apps, applications, and the like) that can be sold on the marketplace 503. By way of example and not limitation, the content provider 504 can be a videogame company that creates a game to be made available for download from the marketplace 503. By way of another example and not limitation, a bank can develop a mobile banking application that is communicated to the marketplace 503 and made available for download via the marketplace 503. In such example, the bank is the content provider 504. Additionally, the bank may host the mobile banking application on the bank's website for download or delivery to users. It is to be appreciated and understood that the content provider 504 is not limited to these examples and the content provider 504 can he any suitable entity (e.g., user, company, business, group of users, and the like) that creates or develops content 514 to be distributed to the marketplace host 513 for download via the marketplace 503.

The marketplace host 513 maintains the marketplace 503 on a network. The marketplace host 513 owns and/or controls a host server that contains the marketplace 503, and provides the user access to the marketplace 503. The marketplace host 513 can further control an amount of bandwidth allocated to the user to download the content 514 of the one or more content providers 504. In a non-limiting embodiment, the marketplace host 513 can own and/or control the marketplace 503. In another non-limiting embodiment, the marketplace host 513 can host the marketplace 503 on a network to enable access by the user.

In an exemplary embodiment, a user accesses the marketplace 503 via the marketplace application 533 located on the computing device 501. The computing device 501 can have access to the network 505, and the computing device 501 can communicate data in the form of a query to the marketplace host 513, wherein the data can be a request for information on content 514. The marketplace host 513 can communicate data in the form of a query result (which can include content 514) via a network to the computing device 501 for review, install, use, storage, and the like. In a non-limiting embodiment, the computing device 501 can include a user-interface that displays the data (e.g., the query, the query result, the content 514, among others) for the user.

Prior to download of content 514, the user can further navigate information regarding the content 514 that is displayed and select to either request additional content 514 or to purchase the content 514. If the user selects to purchase content 514, the marketplace application 533 communicates a purchase request to the marketplace host 513. The marketplace host 513 can then use the transaction system 515 which includes the transaction gateway charging the user account if data related to the user account is available, and if the user account is not available, then the marketplace host 513 can request user account 512 information from the user which can then be sent to the transaction gateway. Upon receipt of the user account information, the transaction gateway can charge the user account, and send a confirmation of the transaction hack to the marketplace host 513.

The marketplace host 513 can then communicate the confirmation information to the computing device 501, as well as enable the user to download data for the content 514 and/or the marketplace application 533 stored in a host server regarding the specific content 514 and/or marketplace application 533 purchased. The marketplace application 533 can further assist with installation of the content 514 or marketplace application 533 purchased onto the computing device 501. It is to be appreciated and understood that the above process can occur in any order, such as a downloading of application information from the marketplace host 513 prior to the transaction and the order of the above described process is not to be limiting on the subject innovation.

One of ordinary skill in the art can appreciate that the various embodiments of a subscription-based diagnostic software service described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can he aggregated and exposed according to various levels of Abstraction for use by application or service providers, to provide computing services or functionality to client computing devices. The client computing devices can access the computing services or functionality via application program interfaces (APIs), web browsers, or other standalone or networked applications. Accordingly, aspects of the subscription-based diagnostic software service can be implemented based on such a cloud environment. For example, the service advisor application 202 can reside in the cloud environment such that the computer-executable instruction implementing, the functionality thereof are executed with the aggregated computing resources provided by the plurality of physical computing devices. The cloud environment provides one or more methods of access to the subject innovation, which are utilized the service advisor application 202. In an embodiment, software and/or a component can be installed on a mobile device to allow data communication between the mobile device and the cloud environment. These methods of access include IP addresses, domain names, URLs, etc. Since the aggregated computing resources can be provided by physical computing device remotely located from one another, the cloud environment can include additional devices such as a routers, load balancers, switches, etc., that appropriately coordinate network data.

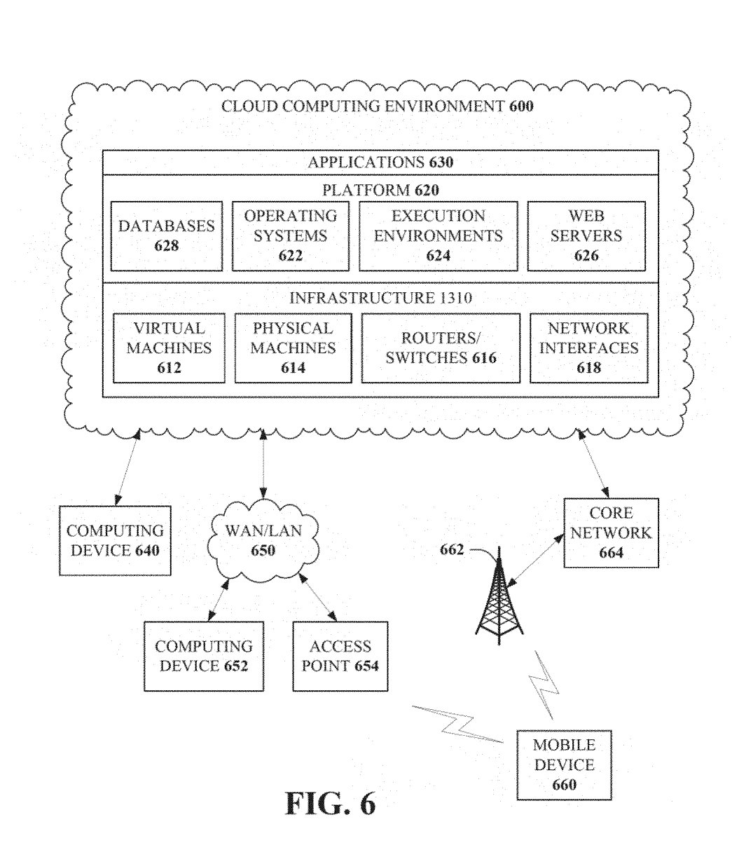

FIG. 6 provides a schematic diagram of an exemplary networked or distributed computing environment, such as a cloud computing environment 600. The cloud computing environment 600 represents a collection of computing resources available, typically via the Internet, to one or more client devices. The cloud computing environment 600 comprises various levels of abstraction: infrastructure 610, a platform 620, and applications 630. Each level, from infrastructure 610 to applications 630 is generally implemented on top of lower levels, with infrastructure 610 representing the lowest level.

Infrastructure 610 generally encompasses the physical resources and components on which cloud services are deployed. For instance, infrastructure 610 can include virtual machines 612, physical machines 614, routers/switches 616, and network interfaces 618. The network interfaces 618 provide access to the cloud computing environment 600, via the Internet or other network, from client devices such as computing, devices 640, 652, 660, etc. That is, network interfaces 618 provide an outermost boundary of cloud computing environment 600 and can couple the cloud computing environment 600 to other networks, the Internet, and client computing devices. Routers/switches 616 couple the network interfaces 618 to physical machines 614, which are computing devices comprising computer processors, memory, mass storage devices, etc. Hardware of physical machines 614 can be virtualized to provide virtual machines 612. In an aspect, virtual machines 612 can be executed on one or more physical machines 614. That is, one physical machine 614 can include a plurality of virtual machines 612.

Implemented on infrastructure 610, platform 620 includes software that for a foundation for applications 630. The software forming platform 620 includes operating systems 622, programming or execution environments 624, web servers 626, and databases 628. The software of platform 620 can be installed on virtual machines 612 and/or physical machines 614.

Applications 630 include user-facing software applications, implemented on platform 620, that provide services to various client devices. In this regard, at least the service advisor application 204 as described herein is an example application 630. As illustrated in FIG. 6, client devices can include computing devices 640, 652 and mobile device 660. Computing devices 640, 652 can be directly coupled to the Internet, and therefore the cloud computing environment 600, or indirectly coupled to the Internet via a WAN/LAN 650. The WAN/LAN 650 can include an access point 654 that enables wireless communications (e.g., with mobile device 660. In this regard, via access point 654 and \VAN/LAN 650, mobile device 660 can communicate wirelessly with the cloud computing environment 600. Mobile device 660 can also wirelessly communicate according to cellular technology such as, but not limited to, GSM, LTE, WiMAX, HSPA, etc. Accordingly, mobile device 660 can wireless communicate with a base station 662, which is coupled to a core network 664 of a wireless communication provider. The core network 664 includes a gateway to the Internet and, via the Internet, provides a communication path to the cloud computing environment 600.

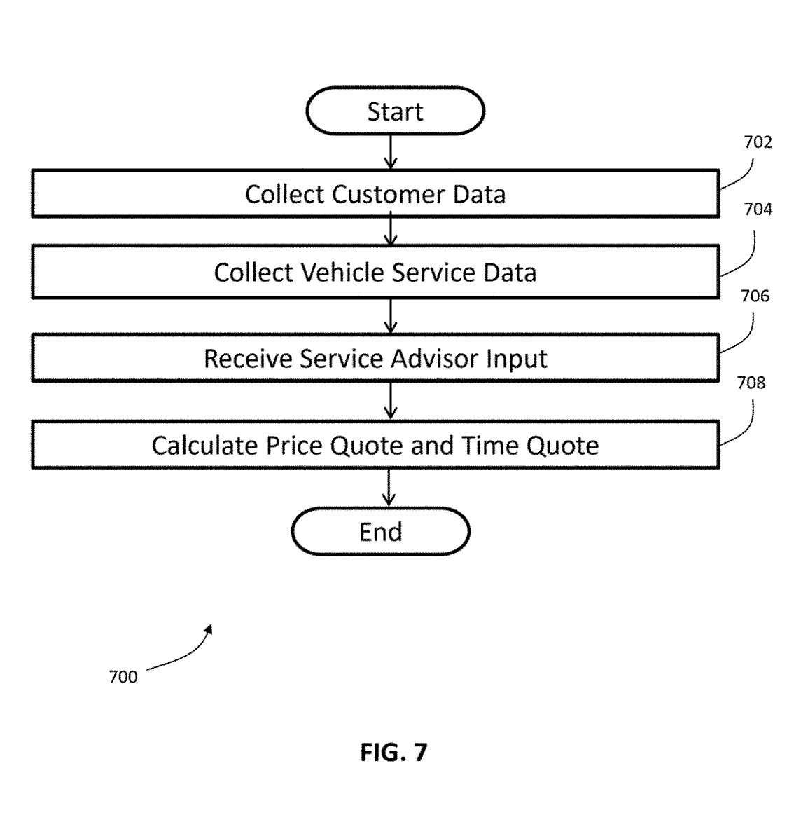

FIG. 7 is a flow chart illustrating an example method 700 for using a vehicle management system for calculating a price quote and a time estimate for a vehicle service. At step 702, the vehicle management system collects customer data associated with a service of a vehicle from a customer and stores the collected data in a data store. At step 704, the vehicle management system collects service data associated with the service of the vehicle, wherein service data comprises estimated costs of service data and estimated time for service completion data, and stores the service data in the data store. At step 706, the vehicle management system receives data input from a service advisor. At step 708, the vehicle management system calculates at least one of a service price quote and a time estimate based on the customer data, the service data, the service advisor input, the stored estimated costs of service data, and stored estimated time for service completion data, using a estimation algorithm.

In an aspect, incorporated is an APPENDIX A (attached). APPENDIX A is a document that describes aspects of the claimed subject matter, and this Appendix forms part of this specification.

In the specification and Claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A vehicle service management system, comprising:
a customer interface module for collecting customer data associated with a service of a vehicle from a customer;
at least one employee interface module for collecting service data associated with the service of the vehicle; and
a service advisor module comprising:
a first communication interface module for communicating with the customer interface module and for receiving the customer data;
a second communication interface module for communicating with the at least one employee interface module and for receiving the service data and to communicate notifications;
a service advisor database for storing the customer data and the service data, wherein the service data comprises estimated costs of service data and estimated time for service completion data;
a service advisor interface configured to display the customer data and the service data; and
to receive inputs from a service advisor; and
an estimator module for calculating at least one of a service price quote and a time estimate based on the customer data, the service data, the service advisor input, the stored estimated costs of service data, and stored estimated time for service completion data, using a estimation algorithm.

2. The vehicle service management system of claim 1, wherein the customer interface module comprises a check-in module for receiving, notification of a customer arrival and for communicating the notification of the customer arrival to the first communication interface.

3. The vehicle service management system of claim 1, wherein the service advisor module further comprises a management module for enabling editing of customer profile data.

4. The vehicle service management system of claim 1, wherein the service advisor database further stores schedule data and inventory data.

5. The vehicle service management system of claim 1, wherein the stored customer data comprises at least one of customer account information, user names, passwords, customer names, customer addresses, customer payment information, and customer vehicle information.

6. The vehicle service management system of claim 1, wherein the service advisor module further comprises a settings module for enabling configuration of parameters.

7. The vehicle service management system of claim 1, wherein the service advisor module further comprises an appointment module for facilitating scheduling of service appointments.

8. The vehicle service management system of claim 7, wherein the appointment module receives customer information from the service advisor database and communicates customer information to a service advisor.

9. The vehicle service management system of claim 1, wherein the service advisor module further comprises a recall search module for receiving and aggregating recall data from one or more automotive manufacturers; to automatically associate recall information with a customer based on the stored customer data; and to provide a notification regarding the recall to one of the customer or the service advisor.

10. The vehicle service management system of claim 2, wherein the service advisor module further comprises a check-in alert module for receiving notification of a customer arrival from the customer interface module and for providing an alert of the customer arrival.

11. The vehicle service management system of claim 1, wherein the service advisor module further comprises a notification module for facilitating message communication between a plurality of employees.

12. The vehicle service management system of claim 11, wherein the notification module enables a sender of a communication to specify a code representative of the type of message being communicated.

13. The vehicle service management system of claim 1, wherein the service advisor module further comprises a schedule module for aggregating and organizing employee work schedules.

14. The vehicle service management system of claim 13, wherein the schedule module integrates with the appointment module to ensure staffing for scheduled services.
